(19) United States
(12) Patent Application Publication
(10) Pub. No.: US 2009/0312053 A1
(43) Pub. Date: Dec. 17, 2009

(54) RADIO FREQUENCY IDENTIFICATION READER FOR DETACHING MOBILE TERMINAL

(75) Inventor: Hyun Woo An, Seoul (KR)

Correspondence Address: CANTOR COLBURN, LLP, 20 Church Street, 22nd Floor, Hartford, CT, 06103, US

(73) Assignee: BLUEBIRD SOFT CO., LTD., Seoul (KR)

(21) Appl. No.: 12/519,636

(22) PCT Filed: Dec. 17, 2007
(86) PCT No.: PCT/KR2007/006600

§ 371 Date: Jun. 17, 2009

(30) Foreign Application Priority Data
Dec. 18, 2006 (KR) 10-2006-0129091
Dec. 18, 2006 (KR) 10-2006-0129092

(51) Int. Cl. G06K 7/02; H04M 1/00

(52) U.S. Cl. 455/556.2; 340/10.1

(57) ABSTRACT

Provided is a radio frequency identification (RFID) reader in which a mobile terminal is mounted. The RFID reader comprise a reader body; an RFID reading portion which forms a front of the reader body and includes an RFID module which reads information in an RFID tag by being placed close to the RFID tag; a pocket portion which is connected to a top of the reader body and includes a connection terminal portion which is connectable with a terminal portion of the mobile terminal and is formed on an inner side of the pocket portion; a grip portion which is connected to the reader body in a rear of the RFID reading portion, supports the reader body and to which a switching unit that selectively turns of and off operation of the RFID module is connected; and a control unit which outputs the information of the RFID tag read by the RFID module to the mobile terminal according to operation of the switching unit. According to the present invention, an RFID reader can be used while a mobile terminal such as a PDA is mounted in it, have an effective structure, and also be portable and easy to use.

### TECHNICAL FIELD

The present invention is directed to a radio frequency identification (RFID) reader to which a mobile terminal can be connected, and more specifically, to an RFID reader to which a mobile terminal such as a personal digital assistant is connectable and which is portable and easy to operate and have an efficient structure.

### BACKGROUND ART

Generally, mobile terminals including can be used freely without spatial limitation while users are moving and typical types of such mobile terminals include mobile communications terminals, such as mobile phones, and personal digital assistants (PDAs). Thus, although a term of’ ‘a mobile terminal’ which is used in this specification includes such all kinds of devices, hereinafter, only a PDA will be described for convenience of explanation.

As a society becomes more complicated and diverse, an individual needs to store and maintain their own information more and more, and a variety of products for satisfying these individual's needs are available in markets, and a PDA is one of the widely used mobile terminal products.

A PDA is also called a pocket computer, which is a general term for a device of a palm size with calculation, information storing, and searching functions which is used for personal or business purposes, and is generally used to maintain schedule calendar and address information.

Particularly, an industrial PDA has been more widely used with the development of physical distribution industry and its market has expanded gradually.

The industrial PDA has various businesslike functions, such as a barcode scanner and a credit card settlement function, which are not provided by a general PDA, and allows efficient management of delivery, database, and relevant work. For example, a consultant of an insurance company can directly and immediately manage a variety of insurance related works such as client information management, client search, schedule management, daily consulting record management, search of anniversaries of clients, and funds statement management, using such the industrial PDA. For another example, medical staff can input or search medical record, history and medical treatment of a patient and an X-ray image or graphic data of the patient using the industrial PDA, which the medical staff is carrying, without temporal and spatial restrictions. Also, when patrol or traffic police officers are on outside duty, the police officers can assist a traffic offender to make a payment simultaneously utilizing an industrial PDA when the offender is charged a fine, for which it generally takes the offender two or three days to pay. Hence, hours for outside duty of the police officers can be substantially reduced.

Radio frequency identification is a general term for a technology of processing information of items by using a compact semiconductor chip. More specifically, the RFID technology enables a non-contact recognition system which transmits information of a product and peripheral information of the product using a compact chip, which is attached to a variety of products.

A radio frequency identification system, which includes a reader having reading and decoding functions, an RFID tag including unique information, operation software, and a network, processes information by identifying a thin flat tag fixed to an item.

An RFID tag consists of a semiconductor transponder chip and an antenna, and is categorized into a passive type and an active type. While a passive RFID tag operates by energies provided from a frequency signal of a reader without an internal power source, an active RFID tag has a built-in RF tag battery for self-operation. An RFID tag may be categorized into a silicon-semiconductor chip tag and a non-chip tag which is formed of only an LC element and a plastic or polymer element.

The RFID technology does not need to directly contact or scan an item within a visible band of a reader like in a barcode technology. Having such advantages, the RFID technology is considered as a replacement for a barcode technology, and an application range of the technology expands. A low-frequency (30 kHz-500 kHz) RFID system is used for transmission in a short distance of less than 1.8 m, and a high-frequency (850 MHz-950 MHz or 2.4 GHz-2.5 GHz) RFID system is used for transmission in a long distance of more than 27 m.

Since the RFID tags are widely used for a variety of management systems for, for example, processing management, asset management, physical distribution management, stock management, access control, product tracking, and cultural property protection, researches on an RFID reader adopting the RFID technology have recently been conducted actively, and various types of RFID readers are commercially available. The available RFID readers are categorized from a portable RFID reader applied to an industrial PDA to a fixed RFID reader which is used being fixed onto a table, and its application range is expanding.

However, when the RFID reader function is integrated into a PDA, the size of the PDA becomes bigger than a normal one, thereby causing inconvenience to a user who wants to simply use a PDA. On the other hand, since the fixed RFID reader cannot be carried with a user, the user only can use the fixed RFID reader in a particular place where the RFID reader is available.

Therefore, if an RFID reader to which a PDA can be connected is developed, considering the situation that the PDA is widely used in most industrial fields, it can be expected that a variety of management systems can be more efficiently operated by using such the RFID reader.

For easy use of such the RFID reader, the RFID reader needs to have a pocket portion which the PDA is easily connected to (locked into) and detached (unlocked) from. However, it is certain that the PDA connected to the pocket portion should not be arbitrarily detached from the pocket portion. Hence, it is required to conduct a research on a structure of a RFID reader, which allows a PDA to be easily connected to and detached from a pocket portion, in the course of researching and developing the RFID reader.

### DISCLOSURE OF INVENTION

### Technical Problem

The present invention provides a radio frequency identification (RFID) reader to which a mobile terminal such as a personal digital assistant is connectable and which is portable and easy to operate and have an efficient structure.

The present invention also provides an RFID reader which has a pocket portion that a mobile terminal such as a personal digital assistant (PDA) is easily locked in and unlocked from without difficulty.

### Advantageous Effects

According to a present invention, a radio frequency identification (RFID) reader can have a efficient structure to which a mobile terminal such as a personal digital assistant (PDA) can be connected, and is portable and easy to operate.

Also, a RFID reader has a pocket portion which a mobile terminal such as a PDA can be easily locked into and unlocked from without difficulty.

### DESCRIPTION OF DRAWINGS

FIG. 1 shows a radio frequency identification (RFID) reader to which a mobile terminal is mounted, according to an embodiment of the present invention;

FIG. 2 is a perspective view of the RFID reader in FIG. 1 from a different angle;

FIG. 3 is a front view of the RFID reader in FIG. 2;

FIG. 4 is a projected side view of the RFID reader in FIG. 2 to schematically show inner parts;

FIG. 5 is a front perspective view of a pocket portion of the RFID reader in FIG. 2, from which an elastic projection portion is removed;

FIG. 6 is a rear perspective view of the pocket portion of the RFID reader in FIG. 2, from which a printed circuit board (PCB) is removed;

FIG. 7 is a front perspective view of a top plate of a reader body in FIG. 2;

FIG. 8 is a partly enlarged, exploded perspective view of the top plate in FIG. 7;

FIG. 9 is a perspective view of a locker illustrated in FIG. 8 from a different angle;

FIG. 10 is an enlarged view of a stalker illustrated in FIG. 8;

FIG. 11 is a cross-sectional view of a locker and stalker in FIG. 8 in order to schematically explain movements of the locker and stalker;

FIG. 12 is a front perspective view of a gasket of the RFID reader in FIG. 2;

FIG. 13 is a rear perspective view of the gasket of FIG. 12;

FIG. 14 is a rear perspective view of the top plate of FIG. 7; and

FIG. 15 is a schematic cross-sectional view of a pogo pin area of an auxiliary PCB illustrated in FIG. 6.

### BEST MODE

According to an aspect of the present invention, there is provided a radio frequency identification (RFID) reader in which a mobile terminal can be mounted, the RFID reader comprising: a reader body; an RFID reading portion which forms a front of the reader body and includes an RFID module which reads information in an RFID tag by being placed close to the RFID tag; a pocket portion which is connected to a top of the reader body and includes a connection terminal portion which is connectable with a terminal portion of the mobile terminal and is formed on an inner side of the pocket portion; a grip portion which is connected to the reader body in a rear of the RFID reading portion, supports the reader body and to which a switching unit that selectively turns of and off operation of the RFID module is connected; and a control unit which outputs the information of the RFID tag read by the RFID module to the mobile terminal according to operation of the switching unit.

According to another aspect of the present invention, there is provided an RFID reader in which a mobile terminal can be mounted, the RFID reader comprising: a reader body which includes an RFID module that reads information in an RFID tag by being placed close to the RFID tag to be read and a switching unit that selectively turns on and off operation of the RFID module; a pocket portion which is detachably connected to a top plate that forms a top of the reader body and includes a connection terminal portion that is formed on an inner side of the pocket portion and is connectable to a terminal portion of a mobile terminal interacting with the RFID module; and a locking portion which is provided in the top plate and the pocket portion and selectively locks and unlocks the mobile terminal mounted in the pocket portion.

### MODE FOR INVENTION

Embodiments of the present invention are described in detail in the detailed description and the accompanying drawings. In the specification, like reference numerals in the drawings denote like elements.

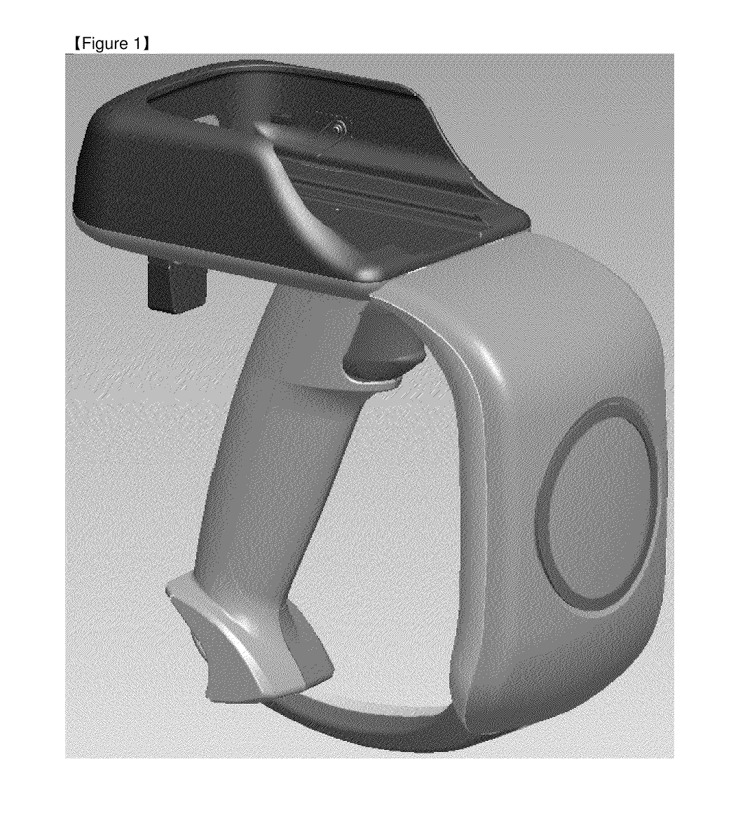

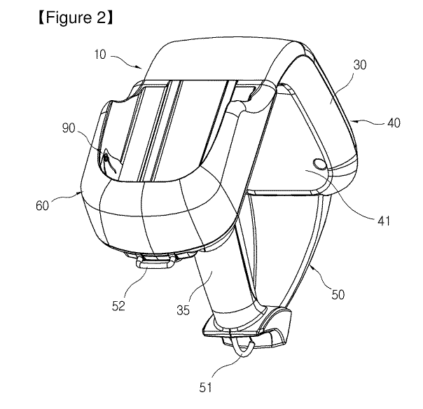

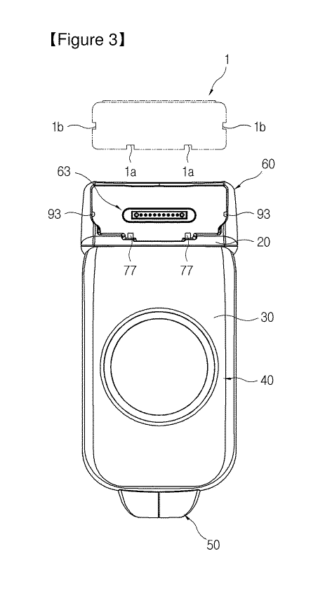

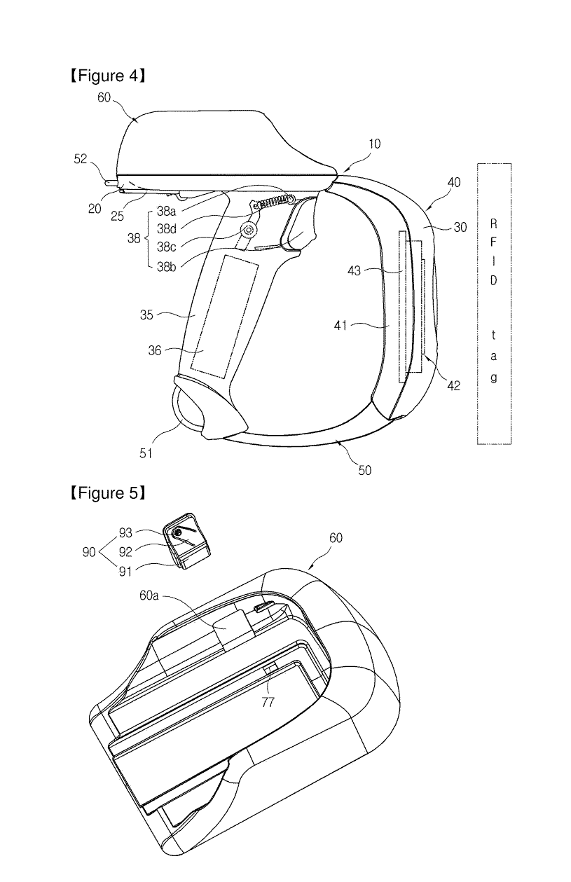

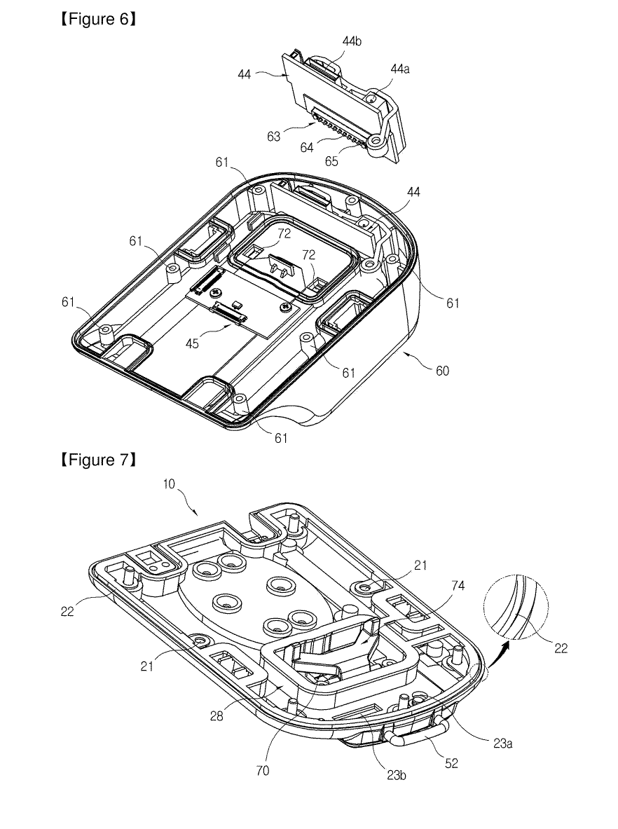

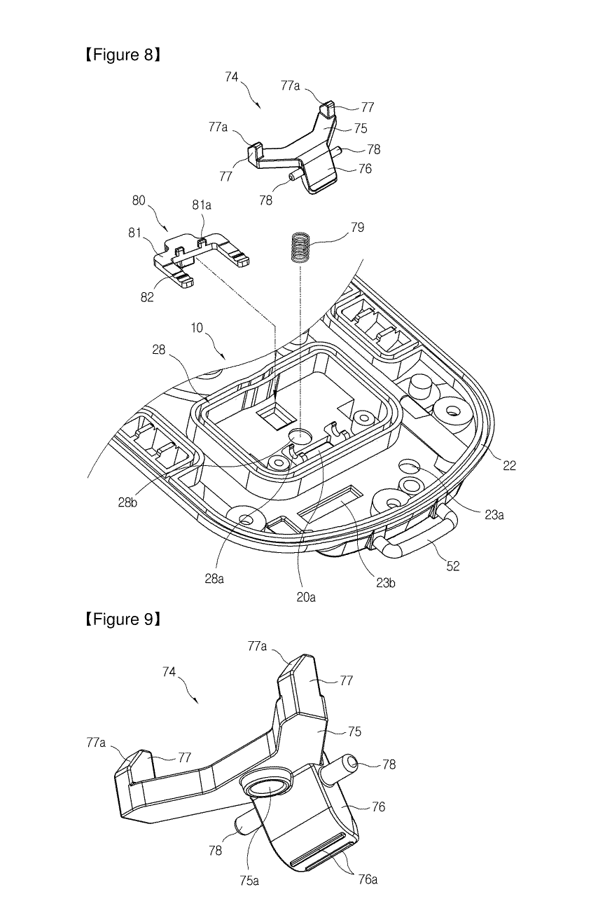

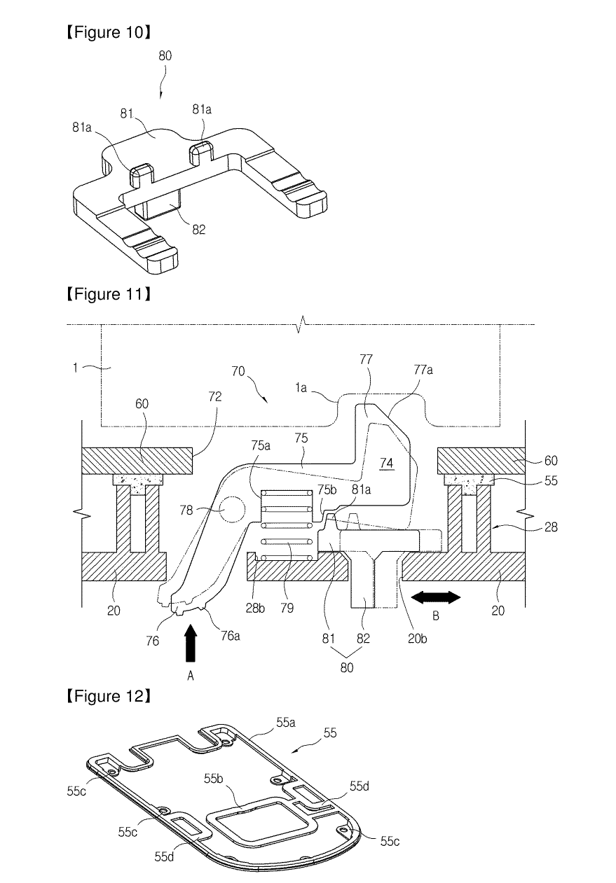

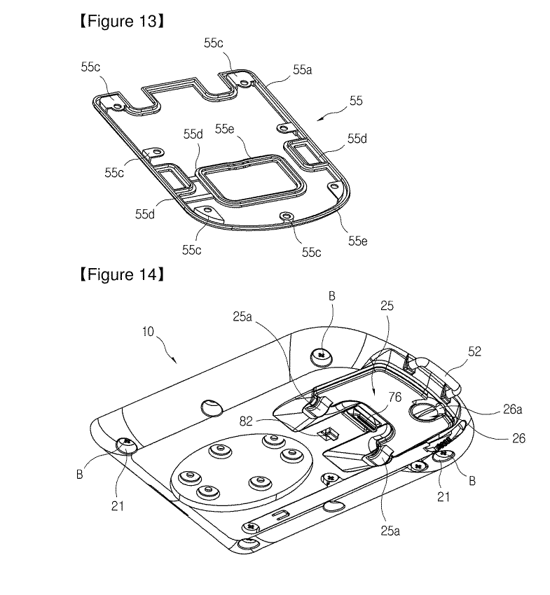

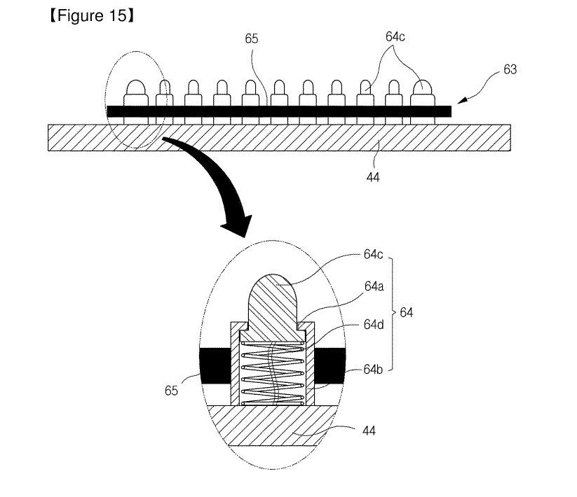

FIG. 1 shows a radio frequency identification (RFID) reader to which a mobile terminal is attached, according to an embodiment of the present invention, FIG. 2 is a perspective view of the RFID reader in FIG. 1 from a different angle, FIG. 3 is a front view of the RFID reader in FIG. 2, and FIG. 4 is a projected side view of the RFID reader in FIG. 2 to schematically show inner parts. FIG. 5 is a front perspective view of a pocket portion 60 of the RFID reader in FIG. 2, from which an elastic projection portion is removed, and FIG. 6 is a rear perspective view of the pocket portion 60 of the RFID reader in FIG. 2, from which a printed circuit board (PCB) is removed. FIG. 7 is a front perspective view of a top plate 20 of a body 10 of the RFID reader in FIG. 2, FIG. 8 is a partly enlarged, exploded perspective view of the top plate 20 in FIG. 7, FIG. 9 is a perspective view of a locker 74 illustrated in FIG. 8 from a different angle, FIG. 10 is an enlarged view of a stalker 80 illustrated in FIG. 8, and FIG. 11 is a cross-sectional view of a locker and stalker in FIG. 8 in order to schematically explain movements of the locker 74 and stalker 80. FIG. 12 is a front perspective view of a gasket of the RFID reader in FIG. 2, and FIG. 13 is a rear perspective view of the gasket of FIG. 12. FIG. 14 is a rear perspective view of the top plate 20 of FIG. 7, and FIG. 15 is a schematic cross-sectional view of a pogo pin area of an auxiliary PCB illustrated in FIG. 6.

Referring to these drawings, especially to FIGS. 1 to 4, a RFID reader to which a mobile terminal can be connected, according to the present invention, includes a reader body 10 which forms a general shape of the RFID reader, an RFID reading portion 40 which forms the front part of the RFID reader and includes an RFID module 42 (referring to FIG. 4), a pocket portion 60 (referring to FIGS. 5 and 6) which is connected to a top of the reader body 10 and a mobile terminal is connected to, a grip portion 35 which is placed at the rear of the RFID reading portion 40 and has a switching unit 38 on its one side in order to selectively turn on and off the operation of the RFID module 42, and a control portion (not shown) which outputs information to the mobile terminal according to the operation of the switching unit 38, the information being stored in an RFID tag and read by RFID module 42.

The RFID reader according to the current embodiment of the present invention is used while an additional mobile terminal is connected to the RFID reader. Thus, a mobile terminal is required in order to use the RFID reader according to the embodiment of the present invention, and such the mobile terminal may be a mobile phone or an industrial or general personal digital assistant (PDA) of any types of shape such as a flip open type and a folder type. In this specification, however, a flip open type industrial PDA 1 (referring to FIGS. 3 and 11) will be described as the mobile phone, hereinafter.

The reader body 10 has the pocket portion 60, which is detachably connected thereto, a top plate 20 (referring to FIGS. 7 and 14) to which a top of the grip portion 35 is connected, and a front plate 30 which forms the front of the RFID reading portion 40. As illustrated in FIGS. 7 and 14, the top plate 20 is substantially flat shaped, whereas the front plate 30 is curved as illustrated in FIGS. 2 and 4. However, the shapes of the plates according to the present invention are not limited thereto.

Referring to FIGS. 1 to 4 again, the RFID reading portion 40 forms a front part of the reader body 10. The RFID reading portion 40 includes the RFID module 42 (referring to FIG. 4) which reads information in an RFID tag (referring to FIG. 4) while placing near the RFID tag to be read. A main printed circuit board (PCB) 43 is connected to the RFID module 42.

The main PCB 43 forms a signal line, which connects the RFID module 42 and a PDA 1, by electrically connecting with an auxiliary PCB 44 (referring to FIG. 6) and a connection PCB 45, respectively, through flexible PCBs (FPCB; not shown).

A module supporting cover 41, which accommodates and supports the main PCB 43 and the RFID module 42 together with the front plate 30, is connected to a rear part of the front plate 30 such that the main PCB 43 and the RFID module 42 can be mounted on the rear of the front plate 30. The module supporting cover 41 may be detachably connected to the rear of the front plate 30 for the maintenance of the module supporting cover 41.

Although it is not illustrated in detail, a structure that allows the module supporting cover 41 to be detachable from the rear of the front plate 30 can be simply implemented by a hook connection and a bolt connection. It might be advantageous that an additional rubber packing is provided between the module supporting cover 41 and the front plate 30 in order to prevent foreign substance or moist from entering a space between the module supporting cover 41 and the front plate 30 after the module supporting cover 41 and the front plate 30 are coupled with each other.

In a lower part of the module supporting cover 41, that is, a lower part of the reader body 10, a connection portion 50 is further included, which has an end that is connected between the front plate 30 and the module supporting cover 41 and the other end that is connected to a lower part of the pocket portion 60, to form a lower part of the reader body 10. The connection portion 50 also supports the RFID reading portion 40 and the pocket portion 60 by connecting the RFID reading portion 40 and the pocket portion 60. In the current embodiment of the present invention, the connection portion 50 is arc-shaped. However, the shape of the connection portion 50 is not limited to an arc-shape. Furthermore, the connection portion 50 may be omitted depending on a design of the RFID reader.

A connection ring 51 is formed on the connection portion 50. A connection ring 52 (referring to FIGS. 2, 7, and 8) is also formed on a front of the top plate 20. The connection rings 51 and 52 is used for hanging the RFID reader on a certain place or holding the RFID reader using a neck string on a user's neck. The connection rings 51 and 52 can be omitted depending on a design of the RFID reader, and can be provided on parts different from what has been described above.

The pocket portion 60 is where the PDA 1 is connected. Thus, the pocket portion 60 has various structural elements such that the PDA 1 is firmly locked into and unlocked from the pocket portion 60 while not being easily loose. Such the elements will be described later.

The pocket portion 60 is connected to an upper part of the reader body 10. More specifically, the pocket portion 60 is connected to the top plate 20 of the reader body 10, which forms the upper part of the reader body 10. To this end, a plurality of coupling holes 21 are formed on the top plate 20, and a plurality of coupling bosses 61, which bolts B (referring to FIG. 14) that pass through the coupling holes 21 are inserted into so that the coupling bosses 61 and the coupling holes 21 are coupled with one another, are formed on the pocket portion 60. Therefore, while the coupling holes 21 of the top plate 20 and the coupling bosses 61 of the pocket portion 60 are connected to one another, the bolts B are inserted into the coupling bosses 61 through the coupling holes 21 so that the pocket portion 60 can be fixed onto a top surface of the top plate 20. To prevent a gap between the pocket portion 60 and the top plate 20 before the pocket portion 60 and the top plate 20 are coupled together, a gasket 55 (referring to FIGS. 12 and 13) are interposed between the pocket portion 60 and the top plate 20.

The gasket 55 is interposed between the top plate 20 and the pocket portion 60 in order to seal a space between the top plate 20 and the pocket portion 60, as shown in FIGS. 12 and 13. Thus, the gasket 55 prevents moist or water from entering the space between the top plate 20 and the pocket portion 60.

To this end, the gasket 55 is designed as a single unit that wholly covers outlines of the top plate 20 and the pocket portion 60 and an area where the top plate 20 and the pocket portion 60 are coupled together facing each other. More specifically, the gasket 55 includes an outline part 55a that is placed on the outlines of the top plate 20 and the pocket portion 60, a unit outline part 55b that is placed on the outline of a locker connecting portion 28, which will be described later, a plurality of connecting parts 55c that are placed on areas of the coupling holes 21 and coupling bosses 61, and dummy parts 55d that are placed on other areas where the top plate 20 and the pocket portion 60 contact each other.

A surface of the gasket 55, which a bottom of the pocket portion 60 touches, is flat, whereas another surface of the gasket 55, which the top plate 20 touches, has a plurality of projection ribs 55e which are inserted and fixed into grooves 22 (referring to FIGS. 7 and 8) formed on each part of the top plate 20. Since the grooves 22 are formed on every part of the top plate 20 including an outline, it may be advantageous that the projection ribs 55e are also formed on the outline part 55a, the unit outline part 55b, the connecting parts 55c and the dummy parts 55d of the gasket 55. Moreover, it is more advantageous that the outline part 55a, the unit outline part 55b, the dummy parts 55d, the connecting parts 55c, the dummy parts 55d and the projection ribs 55e of the gasket 55 are formed of the same material. The material may be rubber or silicon. The pocket portion 60 is box-shaped with its top and one side open in order to have the PDA 1 connected into. Hence, the PDA 1 can be connected with the pocket portion 60, partly accompanied in the pocket portion 60. A rear side of the pocket portion 60, with respect to a direction in which the PDA 1 is inserted, has a connection terminal portion 63 (referring to FIGS. 6 and 15), which is electrically connected to terminals (not shown, data terminal portion) of the PDA 1.

Referring to FIG. 15, the connection terminal portion 63 includes a plurality of pogo pins 64, which are coupled with the auxiliary PCB 44 and correspond to the terminals of the PDA 1 one by one, and a pin supporting block, which supports all the plurality of pogo pins 64 on the auxiliary PCB 44.

Each of the pogo pins 64 has an end which is connected to the auxiliary PCB 44, and another end which has a hollow-shaped pin accommodating part 64b, which an exposing hole 64a is formed on, a pin 64c that is partly accommodated in the pin accommodating part 64b so as to be exposed through the exposing hole 64a of the pin accommodating part 64b, and an elastic member 64d that is placed in the pin accommodating part 64b between a bottom surface of the pin 64c and the auxiliary PCB 44 and elastically biases the pin 64c in a direction in which the pin 64c is exposed.

The bottom surface of the pin 64c which contacts the elastic member 64d has a diameter greater than that of a top of the pin 64c in order to prevent the pin 64c from coming off from the exposing hole 64a of the pin accommodating part 64b, and an inner diameter of the pin accommodating part 64b is nearly the same as an outer diameter of the bottom surface of the pin 64c and an inner diameter of the exposing hole 64a is almost the same as an outer diameter of the top of the pin 64c so that the pin accommodating part 64b corresponds to the shape of the pin 64c. As the result, each pin 64c is pushed in a direction of the exposing hole 64a by the elasticity of the elastic member 64d, but does not come off from the exposing hole 64a. Thus, the pins 64c can be strongly connected with the terminals of the PDA 1, thereby preventing an electrical short.

The auxiliary PCB 44 to which the connection terminal portion 63 is connected, as shown in FIG. 6, has a power supplying terminal portion 44a and a USB (universal serial bus) terminal portion 44b connected thereto. In this case, the power supplying terminal portion 44a and the USB terminal portion 44b, as shown in FIG. 8, are exposed to outside by a first terminal exposing hole 23a and a second exposing hole 23b, respectively. However, if the power supplying terminal portion 44a and the USB terminal portion 44b are always exposed by the first and second terminal exposing holes 23a and 23b, they can be easily contaminated by foreign material. To prevent such the contamination, a terminal cover 25 is formed on the bottom surface of the top plate 20, which the first and second terminal exposing holes 23a and 23b are formed on, as shown in FIG. 14. The terminal cover 25 has a side having hinge portions 25a formed thereon, and opens and covers a side of the top plate 20, where the first and second terminal exposing holes 23a and 23b are formed, by pivoting on the hinge portions 25a as a rotation axis. In FIG. 14, the terminal cover 25 covers the bottom surface of the top plate 20. However, when the terminal cover 25 pivots on the hinge portions 25a, the terminal cover 25 opens the first and second terminal exposing holes 23a and 23b on the top plate 20 so that the power supplying terminal portion 44a and the USB terminal portion 44b are exposed by the first and second terminal exposing holes 23a and 23b.

At this time, to prevent the terminal cover 25 from easily pivoting, the bottom surface of the top plate 20 where the terminal cover 25 is placed has a stop-knob 26 which selectively restricts the pivoting of the terminal cover 25. The stop-knob 26 selectively restricts the pivoting of the terminal cover 25 using a projection terminal 26a formed on its side by rotating together with the bolt forward and reversely.

Referring to FIG. 4 again, the grip portion 35 is formed on the RFID reader so that a user can easily carry and use the RFID reader. As described above, the grip portion 35 is connected to the rear of the RFID reader 40 to support the reader body 10, and has the end to which the switching unit 38 is connected to selectively turn on/off the operation of the RFID module 42. Moreover, a changeable battery 36 is further included inside of the grip portion 35. To change the changeable battery 36, like the RFID reading portion 45 described above, the grip portion 35 has a structure by which it can be detachable by a rear cover (not shown).

The switching unit 38 is placed at the front of the grip portion 35 when a user is holding the grip portion 35. The switching unit 38 is placed to be exposed from a side of the grip portion 35, as schematically illustrated in FIG. 4, and includes a press button portion 38b which pivots on a pivot axis 38a on its side, a module operating portion 38c which operates the RFID module 42 based on the pivoting of the press button portion 38b, and a reverting spring which is connected to the press button portion 38b and reverts the press button portion 38b to the original position. By these elements, when a user is holding the grip portion 35 entirely and presses the press button portion 38b with a finger, the press button portion 38b pivots on the pivot axis 38a to operate the module operating unit 38c, so that the RFID module 42 is operated. When the user releases the press button portion 38b, the press button portion 38b is reverted to the original position by the reverting spring 38d.

As described above, the pocket portion 60 formed on the top of the reader body 10 is where the PDA 1 is connected. Hence, the pocket portion 60 has various elements that firmly locks and unlocks the PDA 1 while preventing the PDA 1 from loosening from the pocket portion 60. With reference to FIGS. 3, and 5 to 11, such the elements will be described in detail below.

A locking portion 70 (referring to FIG. 7) which selectively locks and unlocks the PDA 1 that is connected to the pocket portion 60 is formed on the top plate 20 and the pocket portion 60 in order that the PDA 1 is firmly connected to the pocket portion 60 and easily detached from the pocket portion 60.

The locking portion 70 is coupled with a plurality of locking slots 72 (referring to FIG. 6), which are formed on the bottom surface of the pocket portion 60, and the top plate 20 such that the locking portion 70 can pivot at least in one direction. Also, the locking portion 70 includes a locker 74 (referring to FIGS. 8, 9, and 11) which has an end exposed to the bottom surface of the top plate 20 and the other ends each of which passes through the locking slot 72 to be exposed to the inside of the pocket portion 60.

Each locking slot 72 penetrates the bottom surface of the pocket portion 60. In the current embodiment of the present invention, there is a pair of locking slots 72 apart from each other on the bottom surface of the pocket portion 60.

The locker 74 is connected to the inside of the locker connecting portion 28 formed on the top surface of the top plate 20. The locker 74 includes a body portion 74, a press button portion 76, a pair of hooking portions 77, and rotation axes 78. The body portion 74 is disposed in a space between the top plate 20 and the pocket portion 60. The press button portion 76 expands downward from a side of the body portion 74 and has an end that is exposed to the bottom surface of the top plate 20 through a hole 20a formed on the flat surface of the top plate 20 to operate the locker 74. The pair of hooking portions 77 extend upward from each side of the body portion 75, and have ends which are exposed through the pair of locking slots 72 and are selectively hooked in and unhooked from a hooking groove 1a (referring to FIGS. 3 and 11) which is formed on the bottom surface of the PDA 1. The rotation axes 78 are formed on the press button portion 76 to form a rotation axis of the locker 74.

The body portion 75 simultaneously supports the press button portion 76 and the pair of hooking portions 77 and is angular semicircular. However, the shape of the body portion 75 according to the present invention is not limited to the angular semicircular shape.

The press button portion 76 substantially drives the locker 74. That is, the user can detach the PDA 1 from the pocket portion 60 by pressing the press button portion 76. The press button portion 76 is arc-shaped so that the pair of hooking portions 76 can pivot inside of the pair of locking slots 72 when the press button portion 76 is pressed in a direction of the flat surface of the top plate 20. Also, antiskid steps are formed on a surface where the end of the press button portion 76 is exposed.

The pair of hooking portions 77 protrudes upward from each end of the body portion 75. As described above, the pair of hooking portions 77 pass through the hole 20a formed on the flat surface of the top plate, extrude inside of the pocket portion 60, and selectively are hooked in and unhooked from the hooking groove 1a (referring to FIGS. 3 and 11) formed on the bottom surface of the PDA 1. Slopes 77a which slant in a direction in which the PDA 1 is connected to the pocket portion 60 are formed on each end of the pair of the hooking portions 77. The PDA 1 is easily connected to the pocket portion 60 by the slopes 77a.

The rotation axes 78 protrude from each side of the press button portion 76 in a direction opposite to each other. The axes 78 are accommodatingly supported inside of an axis accommodating portion 28a in the locker connecting portion 28, and then fixed by an additional bolt (not shown) to form a rotation axis of the locker 74.

An elastic member 79, which elastically biases the locker 74 in a direction in which the locker 74 is reverted to the original location when the press button portion 76 is released, is provided between the body portion 75 and the locker connecting portion 28. The elastic member 79 has ends which are respectively fixed into a groove 28b formed on the bottom surface of the locker connecting portion 28 and a groove 75a formed on the bottom surface of the body portion 75 such that both ends are partly accommodated in these grooves 28b and 75a.

While the PDA 1 is being mounted in the pocket portion 60, as illustrated in FIG. 11, if the user presses the press button portion 73 in a direction A, the locker 74 pivots on the rotation axis 78 in a predetermined direction (from a direction of a solid line to a direction of a dotted line) by the pressing force. The pair of hooking portions 77 can be released from the hooking groove 1a formed on the bottom surface of the PDA 1 by the pivoting of the locker 74. When the user releases the press button portion 76, the locker 74 returns to the original position by the elastic resistance force of the elastic member 79 (from a direction of the dotted line to a direction of the solid line).

As such, by a simple operation of user's pressing the press button, the pair of hooking portion 77 can be released from the hooking groove 1a formed on the bottom surface of the PDA 1. However, the press button portion 76 should not be pressed accidentally or intentionally during using the RFID reader because if the press button portion 76 is pressed, the PDA 1 can be detached from the pocket portion 60. To prevent the PDA 1 from being detached from the pocket portion 60 accidentally, a stopper 80 is further included.

As illustrated in FIGS. 8, 10, and 11, the stopper 80, which is connected to the top plate 20 close to the locker 74 and can move in a predetermined direction, selectively restricts the movement of the locker 74.

The stopper 80 includes a stopper body 81, and a stopper rod 82. The stopper body 81 is selectively located on the bottom surface of the body portion 75 of the locker 74 and restricts the movement of the locker 74 while moving in a direction of the flat surface of the top plate 20. The stopper rod 82 extends downward from the stopper body 81, is exposed through a penetration hole 20b formed on the bottom surface of the top plate 20, and operates the stopper body 81.

Projection portions 81a, which are selectively disposed to face a step projection portion 75b formed on the body portion 75 of the locker 74, are formed on the stopper body 81. Substantially, the movement of the locker 74 is restricted by the projection portions 81a disposed facing the step projection portion 75b. For example, as illustrated in FIG. 11, if the stopper 80 moves in a direction B, the movement of the locker 74 is restricted when, as illustrated by the solid line, the projection portions 81a are disposed facing the step projection portion 75b, and when the stopper 80 moves in a direction of the dotted line and consequently, the projection portions 81a are released from the step projection portion 75b, the locker 74 can move freely.

With only the described-above structure of the locking portion 70, the PDA 1 can be sufficiently locked into and unlocked from the pocket portion 60. However, in some cases, the connection between the PDA 1 and the pocket portion 60 may be rather weak.

To supplement the connection strength between the PDA 1 and the pocket portion 60, elastic projection portions 90 (referring to FIG. 5) are further included in the pocket portion 60. Each of the elastic projection portion 90 is connected to an inner wall of the pocket portion 60 and is elastically hooked in and unhooked from a groove 1b (referring to FIG. 3) formed on a side wall of the PDA 1. That is, the elastic projection portion 90 supports the PDA 1 inside the pocket portion 60, together with the locking portion 70.

The elastic projection portion 90 includes a projection supporting plate 91, a leaf spring bending portion 92, and an elastic projection 93. The projection supporting plate 91 is connected to the inner wall of the pocket portion 60. The leaf spring bending portion 92 is formed on the projection supporting plate 91 while being bent from the projection supporting plate 91 with one of its ends open, and is elastically movable in a horizontal direction with respect to a direction in which the PDA 1 is mounted in the pocket portion 60. The elastic projection 93 is formed to protrude from the leaf spring bending portion 92 toward the inside of the pocket portion 60 and is selectively inserted into the groove 1b formed a side wall of the PDA 1.

The elastic projection portion 90 is inserted into a facing projection fixing hole 60a formed each inner wall of the pocket portion 60. However, the elastic projection portion 90 of the present invention is not limited thereto, and the elastic projection portion 90 may be integrally formed on the inner wall of the pocket portion 60.

When the PDA 1 is mounted in the pocket portion 60, the hooking groove 1a of the PDA 1 is hooked in the hooking portions 77 of the locker 74, and at the same time, the elastic projection 91 is inserted into the groove 1b formed on the side wall of the PDA 1. That is, when the PDA 1 is inserted into the pocket portion 60, the leaf spring bending portion 92 is pushed backwards with respect to the projection supporting plate 91, and then when the groove 92 reaches an area of the elastic projection 93, the leaf spring bending portion 92 protrudes to an original position with respect to the projection supporting plate 91, so that the elastic projection 93 can be connected with the groove 1b.

Operation of the RFID reader having the configuration described above will be briefly described below.

The PDA 1 is pushed into the pocket portion 60 while being partly accommodated in the pocket portion 60 in order to be mounted in the pocket portion 60. Then, the locker 74 is pushed in a predetermined direction with respect to the rotation axes 78, and finally the pair of hooking portions 77 are hooked in the hooking groove 1a formed on the bottom surface of the PDA 1. At the same time, the leaf spring bending portion 92 pushed backwards with respect to the projection supporting plate 91 protrudes forwards and thus the elastic projection 93 can be connected with the groove 1b formed on the side of the PDA 1.

While the PDA 1 is mounted in the pocket portion 60, the user holds the grip portion 35 and then places the RFID reading portion 40 close to a RFID tag (referring to FIG. 4) to be read. Then, the user presses the press button portion 38b on the switching unit 38 with a user's finger. Accordingly, the press button portion 38b pivots on the pivot axis 38a and operates the module operating portion 38c, which operates the RFID module 42, and the RFID module 42 reads information in the RFID tag to be read. The read result is transmitted to the auxiliary PCB 44 through the main PCB 43, and then is output and stored to a display of the PDA 1 through the connection terminal portion 63. Through these procedures, a variety of management systems are performed.

Once the user finishes using the RFID reader, as illustrated in FIG. 11, the user presses the press button portion 76 in a direction A in order to detach the PDA 1 from the pocket portion 60. Then, by the pressing force, the locker 74 rotates with respect to the rotation axes 78 in a predetermined direction (from a direction of a solid line to a direction of a dotted line). The rotation of the locker 74 enables the pair of hooking portions 77 to be released from the hooking groove 1a formed on the bottom surface of the PDA 1. In this state, the user can pull out the PDA 1 from the pocket portion 60. Afterwards, when the user releases the press button portion 76, the locker 74 returns to its original position by the elastic resistant force of the elastic member 79 (from a direction of the dotted line to a direction of the solid line).

As described above, according to the embodiment of the present invention, an RFID reader can be used while a mobile terminal such as a PDA is mounted in it, have an effective structure, and also be portable and easy to use. Thus, a user can perform various management systems effectively no matter when and no matter where the user wants.

In addition, according to the embodiment of the present invention, a mobile terminal such as a PDA can be easily locked in and unlocked from a pocket portion without any difficulties.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

An RFID reader can be used while a mobile terminal such as a PDA is mounted in it, have an efficient structure, and also be portable and easy to use.

Also, a mobile terminal such as a PDA can be easily locked in and unlocked from a pocket portion of an RFID reader without any difficulties.

1. A radio frequency identification (RFID) reader in which a mobile terminal can be mounted, the RFID reader comprising:
a reader body;
an RFID reading portion which forms a front of the reader body and includes an RFID module which reads information in an RFID tag by being placed close to the RFID tag;
a pocket portion which is connected to a top of the reader body and includes a connection terminal portion which is connectable with a terminal portion of the mobile terminal and is formed on an inner side of the pocket portion;
a grip portion which is connected to the reader body in a rear of the RFID reading portion, supports the reader body and to which a switching unit that selectively turns of and off operation of the RFID module is connected; and
a control unit which outputs the information of the RFID tag read by the RFID module to the mobile terminal according to operation of the switching unit.

2. The RFID reader of claim 1, wherein the reader body includes a top plate which the pocket portion is detachably connected to, has an end which a top of the grip portion is connected to and is flat, and a front plate which forms a front surface of the RFID reading portion and is curved.

3. The RFID reader of claim 2, wherein a module supporting cover that accommodatingly supports the RFID module is detachably coupled with a rear surface of the front plate;
further comprising an arc-shaped connection portion which has an end that is connected between the front plate and the module supporting cover and another end that is connected to the lower part of the pocket portion to form a lower part of the reader body.

4. (canceled)

5. The RFID reader of claim 1, wherein an auxiliary printed circuit board (PCB) where the connection terminal portion is connected and a connection PCB apart from the auxiliary PCB are provided in the pocket portion, a main PCB is provided in the RFID module and each of the main PCB, the connection PCB and the auxiliary PCB is electrically connected to a flexible printed circuit board (FPCB).

6. The RFID reader of claim 5, wherein the connection terminal portion includes a plurality of pogo pins which are connected on the auxiliary PCB to correspond to a terminal portion formed on the mobile terminal and a pin supporting block which all the plurality of pogo pins on the auxiliary PCB;
wherein each of the plurality of pogo pins includes a pin accommodating portion, which has an end that is connected to the auxiliary PCB, another end that protrudes along a horizontal direction of a surface of the auxiliary PCB, and an exposing hole formed on an exposed end, a pin which is partly accommodated in the pin accommodating portion in order that its end is exposed to the outside through the exposing hole, an elastic member which is provided in the pin accommodating portion, has two ends disposed between the auxiliary PCB and the pin and elastically biases the pin in a direction in which the pin is exposed from the pin accommodating portion, and a detachment preventing portion which is provided to an end of the pin that contacts the elastic member and is formed to be greater than an inner diameter of the exposing hole in order to prevent the pin from being released from the exposing hole.

7. (canceled)

8. The RFID reader of claim 5. wherein the auxiliary PCB has a power supplying terminal portion and a universal serial bus (USB) terminal connected thereto and the power supplying terminal portion and the USB terminal portion are respectively exposed through first and second terminal exposing holes.

9. The RFID reader of claim 8, wherein on a bottom surface of the top plate on which the first and second terminal exposing holes are formed, a terminal cover that pivots on a hinge portion to open and close a side of the top plate.

10. The RFID reader of claim 9, wherein a restriction knob which is provided on the bottom surface of the top plate and selectively restricts the pivoting of the terminal cover.

11. The RFID reader of claim 1, wherein the switching unit includes a press button portion, which is exposed from a side of the grip portion and pivots on a pivot axis on a side of the press button portion, a module operating portion, which operates the RFID module according to the pivoting of the press button portion, and a reverting spring, which is connected to the press button portion, and returns the press button portion to an original position.

12. The RFID reader of claim 1, further comprising:
a changeable battery which is included inside the grip portion and supplies power to the RFID module; and
a connection ring which is formed on at least one of the reader body and the grip portion;
wherein the mobile terminal is an industrial personal digital assistant.

13. The RFID reader of claim 2, wherein the top plate includes a locking portion which is formed on the top plate and the pocket portion and selectively locks and unlocks the mobile terminal in and from the pocket portion.

14. The RFID reader of claim 13, wherein the locking portion includes a pair of locking slots which are placed in a distance from each other on the bottom surface of the pocket portion, and a locker which is connected to the top plate in a manner that the locker can pivot in at least one direction, has an end that is exposed to the bottom of the top plate and another end that passes through the locking slots and is exposed to the inside of the pocket portion.

15. The RFID reader of claim 14, wherein the locker includes a body which is disposed in a space between the top plate and the pocket portion, a press button portion which extends downwards from a side of the body and has an end that is exposed to the bottom of the top plate through a hole formed on a surface of the top plate, a pair of hooking portions which extends upwards from each side of the body and has an end that is exposed through the pair of the locking slots to be selectively locked in and unlocked from a hooking groove formed on the bottom of the mobile terminal, and rotation axes that are formed on at least one of the body and the press button portion to form a rotation axis of the locker.

16. The RFID reader of claim 15, wherein the locker is connected to a locker connection portion formed on a top surface of the top plate, the rotation axes protrude outwards from each side of the press button and are accommodated and supported by an axis accommodating portion formed inside of the locker connecting portion and an elastic member elastically biases the locker in a direction in which the locker returns to an original position when the press button portion is released.

17. The RFID reader of claim 15, wherein the press button portion is arc-shaped so that the pair of hooking portions can rotate in the pair of locking slots when the press button portion is pressed in a direction of the flat surface of the press button portion and antiskid steps are formed on the exposed surface of the press button portion;
wherein slopes which slant in a direction in which the mobile terminal is connected to the pocket portion are formed on each end of the pair of the hooking portions.

18. (canceled)

19. The RFID reader of claim 14, further comprising:
a stopper which is connected to the top plate close to the locker and can move in a predetermined direction and selectively restricts the movement of the locker.

20. The RFID reader of claim 19, wherein the stopper includes a stopper body which is selectively located on the bottom surface of the body portion of the locker and restricts the movement of the locker while moving in a direction of the flat surface of the top plate and the stopper rod extends downward from the stopper body, is exposed through a penetration hole formed on the bottom surface of the top plate, and operates the stopper body.

21. The RFID reader of claim 20, further comprising:
a projection portion which is formed on the stopper body and selectively disposed on a step projection portion formed on the body of the locker; and
elastic projection portions which are formed on each inner side of the pocket portion and elastically locked in and unlocked from a groove formed on a side of the mobile terminal;
wherein the elastic projection portions includes a projection supporting plate, which is connected to the inner wall of the pocket portion a leaf spring bending portion, which is formed on the projection supporting plate while being bent from the projection supporting plate with one of its ends open, and is elastically movable in a horizontal direction with respect to a direction in which the PDA is mounted in the pocket portion and an elastic projection which is formed to protrude from the leaf spring bending portion toward the inside of the pocket portion and is selectively inserted into the groove formed a side wall of the mobile terminal.

22. (canceled)

23. The RFID reader of claim 2, further comprising:
a gasket which is interposed between the top plate and the pocket portion in order to seal a space between the top plate and the pocket portion, is designed as a single unit that wholly covers outlines of the top plate and the pocket portion and an area where the top plate and the pocket portion are coupled together facing each other, and includes projection ribs which are formed on at least one side of the gasket and inserted and fixed into grooves formed on corresponding parts of the top plate.

24. (canceled)

25. An RFID reader in which a mobile terminal can be mounted, the RFID reader comprising:
a reader body which includes an RFID module that reads information in an RFID tag by being placed close to the RFID tag to be read and a switching unit that selectively turns on and off operation of the RFID module;
a pocket portion which is detachably connected to a top plate that forms a top of the reader body and includes a connection terminal portion that is formed on an inner side of the pocket portion and is connectable to a terminal portion of a mobile terminal interacting with the RFID module; and
a locking portion which is provided in the top plate and the pocket portion and selectively locks and unlocks the mobile terminal mounted in the pocket portion;
wherein the locking portion includes a pair of locking slots, which are formed in a distance from each other on a bottom surface of the pocket portion, and a locker which has an end that is exposed to the bottom of the top plate and another end which passes through the locking slots and is exposed to inside of the pocket portion.

26. (canceled)
